(19) United States
(12) Patent Application Publication
(10) Pub. No.: US 2021/0345446 A1
(43) Pub. Date: Nov. 4, 2021

(54) METHOD AND APPARATUS FOR REMOVING USER PLAN CONNECTIONS IN MULTI-CONNECTIVITY SYSTEMS

(71) Applicant: ZTE CORPORATION, Shenzhen (CN)

(72) Inventors: Zijiang MA, Shenzhen (CN); Yin GAO, Shenzhen (CN); Li YANG, Shenzhen (CN)

(73) Assignee: ZTE CORPORATION

(21) Appl. No.: 17/375,029

(22) Filed: Jul. 14, 2021

Related U.S. Application Data
(63) Continuation of application No. PCT/CN2019/072332, filed on Jan. 18, 2019.

(51) Int. Cl. H04W 76/30; H04W 28/12; H04W 28/24; H04W 76/15

(52) U.S. Cl. CPC H04W 76/30; H04W 76/15; H04W 28/24; H04W 28/12

(57) ABSTRACT

A method and apparatus for removing user plane connections in wireless communication systems with multi-connectivity is disclosed. In one embodiment, a method for method for removing at least one first user plane (UP) connection by a first wireless communication node, includes: determining the at least one first UP connection to be removed from a plurality of UP connections; and transmitting a first message to a second wireless communication node, wherein the first message comprises at least one Downlink-Transport Network Layer (DL-TNL) address of the at least one first UP connection to be removed.

### CROSS-REFERENCE TO RELATED APPLICATION

This application claims the benefit of priority under 35 U.S.C. § 120 as a continuation of PCT Patent Application No. PCT/CN2019/072332, filed on Jan. 18, 2019, the disclosure of which is incorporated herein by reference in its entirety.

### TECHNICAL FIELD

This disclosure relates generally to wireless communications and, more particularly, to a method and apparatus for removing user plane connections in wireless communication systems with multi-connectivity.

### BACKGROUND

With a continuous increasing of global smartphone users, mobile data usage and traffic will continue to grow. In New Radio, dual connectivity (DC) are proposed to allow a wireless communication device with multiple transceivers to simultaneously receive data packet from at least two wireless communication nodes, for example a Master gNodeB (MgNB) and a secondary gNodeB (SgNB). In New Radio, a wireless communication device can perform measurement on intra-frequency, inter-frequency and inter-RAT (Radio Access Technology) frequencies. This frequency measurement by the wireless communication device is configured by a Master gNodeB and/or a Secondary gNodeB in order to facilitate mobility management or other radio resource management functions.

### SUMMARY

The exemplary embodiments disclosed herein are directed to solving the issues related to one or more problems presented in the prior art, as well as providing additional features that will become readily apparent by reference to the following detailed description when taken in conjunction with the accompany drawings. In accordance with various embodiments, exemplary systems, methods, and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the invention.

In LTE dual connectivity (DC), a wireless communication device (UE) may have multiple serving cells belong to different wireless communication nodes (eNBs) including a primary eNB (MeNB) and at least one secondary eNB (SeNB), and a primary cell in a MeNB is named as a PCell and a primary cell in a SeNB is named as a PSCell. In new radio (NR) system, a similar DC architecture can be also introduced. In NR-DC, a UE can connect to multiple NR nodes (gNodeB or gNB) including a master gNB (MgNB) and at least one secondary gNB (SgNB or SN). Collectively in this present disclosure hereinafter, a Master Node (MN) is used to describe a MeNB and/or a MgNB; and a Secondary Node (SN) is used to describe a SeNB and a SgNB. Furthermore, serving cells within a MN are grouped together to form a Master Cell Group (MCG), and serving cells within a SN are grouped together to form a Secondary Cell Group (SCG). The MN and the at least one SN of a UE are grouped together to form a Radio Access Network (RAN).

A Protocol Data Unit (PDU) session is established between a core network (CN) and a RAN. The PDU session comprises a Quality of Service Flow (QF). In multi-connectivity, the QF of the PDU session can be further split into at least two separate parts which can be transmitted to the UE through different wireless communication nodes (e.g., MN and SN). The splitting of a QF of a PDU session is determined by the MN of a RAN. GPRS Tunnel Protocol User (GTP-U) Channel, i.e., User Plane (UP) connection, is established between the CN and each of the wireless communication node (e.g., MN and SN) with at least one part of the QF. Each of the at least one user plane connection comprises a pair of upload (UL) and download (DL) UP transport network layer (TNL) addresses. However, when a transmission of a part of a QF on a UP connection between a UE and one of the wireless communication nodes is accomplished, corresponding UP-TNL addresses cannot be removed. Therefore, there exists a need to develop a method and apparatus for removing unnecessary user plane connections between a CN and MN/SN so as to reduce connection complexity between a UE and the MN/SN and improve address space usage on the CN.

In one embodiment, a method for removing at least one first user plane (UP) connection by a first wireless communication node, includes: determining the at least one first UP connection to be removed from a plurality of UP connections; and transmitting a first message to a second wireless communication node, wherein the first message comprises at least one Downlink-Transport Network Layer (DL-TNL) address of the at least one first UP connection to be removed.

In a further embodiment, a method for removing at least one first user plane (UP) connection by a first wireless communication node, includes: receiving a first message from a second wireless communication node, wherein the first message comprises at least one downlink transport network layer (DL-TNL) address of the at least one first UP connection to be removed from a plurality of UP connections, and wherein the at least one first UP connection to be removed is determined by the second wireless communication node.

In a further embodiment, a method for removing at least one first user plane (UP) connection by a first wireless communication node, comprising: receiving a first message from a second wireless communication node, wherein the first message comprises the at least one first UP connection to be removed; removing the at least one first UP connection from a plurality of UP connections; and transmitting a second message to the second wireless communication node, wherein the at least one first UP connection is determined by the second wireless communication node, and wherein the first message further comprises at least one Uplink-Transport Network Layer (UL-TNL) address of the at least one first UP connection.

In a further embodiment, a method for removing at least one first user plane (UP) connection by a first wireless communication node, includes: determining the at least one first UP connection to be removed from a plurality of UP connections; transmitting a first message to a second wireless communication node, wherein the first message comprises at least one Uplink-Transport Network Layer (UL-TNL) address of the at least one first UP connection; receiving a second message from the second wireless communication node; and removing the at least one UL-TNL address of the at least one first UP connection.

Yet in another embodiment, a computing device comprising at least one processor and a memory coupled to the processor, the at least one processor configured to carry out the method.

Yet, in another embodiment, a non-transitory computer-readable medium having stored thereon computer-executable instructions for carrying out the method.

### BRIEF DESCRIPTION OF THE DRAWINGS

Aspects of the present disclosure are best understood from the following detailed description when read with the accompanying figures. It is noted that various features are not necessarily drawn to scale. In fact, the dimensions and geometries of the various features may be arbitrarily increased or reduced for clarity of discussion.

FIG. 1A illustrates an exemplary wireless communication network, in accordance with some embodiments of the present disclosure.

FIG. 1B illustrates a block diagram of an exemplary wireless communication system, in accordance with some embodiments of the present disclosure.

FIG. 2 illustrates a method for removing at least one user plan connection, in accordance with some embodiments of the present disclosure.

FIG. 3 illustrates a method for removing at least one user plan connection, in accordance with some embodiments of the present disclosure.

FIG. 4 illustrates a method for removing at least one user plan connection, in accordance with some embodiments of the present disclosure.

### DETAILED DESCRIPTION

Various exemplary embodiments of the invention are described below with reference to the accompanying figures to enable a person of ordinary skill in the art to make and use the invention. As would be apparent to those of ordinary skill in the art, after reading the present disclosure, various changes or modifications to the examples described herein can be made without departing from the scope of the invention. Thus, the present invention is not limited to the exemplary embodiments and applications described or illustrated herein. Additionally, the specific order or hierarchy of steps in the methods disclosed herein are merely exemplary approaches. Based upon design preferences, the specific order or hierarchy of steps of the disclosed methods or processes can be re-arranged while remaining within the scope of the present invention. Thus, those of ordinary skill in the art will understand that the methods and techniques disclosed herein present various steps or acts in a sample order, and the invention is not limited to the specific order or hierarchy presented unless expressly stated otherwise.

Embodiments of the present invention are described in detail with reference to the accompanying drawings. The same or similar components may be designated by the same or similar reference numerals although they are illustrated in different drawings. Detailed descriptions of constructions or processes well-known in the art may be omitted to avoid obscuring the subject matter of the present invention. Further, the terms are defined in consideration of their functionality in embodiment of the present invention, and may vary according to the intention of a user or an operator, usage, etc. Therefore, the definition should be made on the basis of the overall content of the present specification.

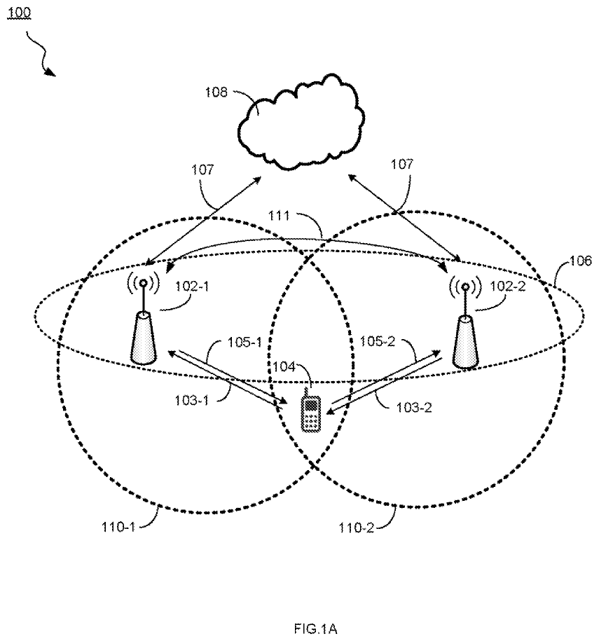

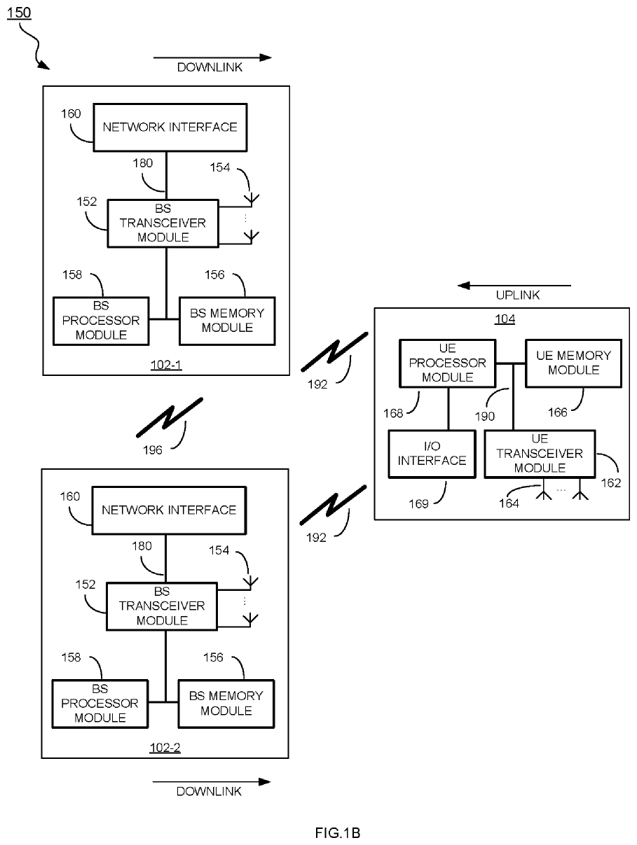

FIG. 1A illustrates an exemplary wireless communication network 100, in accordance with some embodiments of the present disclosure. In a wireless communication system, a network side communication node or a base station (BS) 102 can be a node B, an E-UTRA Node B (also known as Evolved Node B, eNodeB or eNB), a gNodeB (also known as gNB) in new radio (NR) technology, a pico station, a femto station, or the like. A terminal side communication device or a user equipment (UE) 104 can be a long range communication system like a mobile phone, a smart phone, a personal digital assistant (PDA), tablet, laptop computer, or a short range communication system such as, for example a wearable device, a vehicle with a vehicular communication system and the like. A network communication node and a terminal side communication device are represented by a BS 102 and a UE 104, respectively, and in all the embodiments in this disclosure hereafter, and are generally referred to as “communication nodes” and “communication device” herein. Such communication nodes and communication devices may be capable of wireless and/or wired communications, in accordance with various embodiments of the invention. It is noted that all the embodiments are merely preferred examples, and are not intended to limit the present disclosure. Accordingly, it is understood that the system may include any desired combination of BSs 102 and UEs 104, while remaining within the scope of the present disclosure.

Referring to FIG. 1A, the wireless communication network 100 includes a first BS 102-1, a second BS 102-2, and a UE 104. In some embodiments, the UE 104 forms direct communication (i.e., uplink) channels 103-1 and 103-2 with the first BS 102-1 and the second BS 102-2, respectively. In some embodiments, the UE 104 also forms direct communication (i.e., downlink) channels 105-1 and 105-2 with the first BS 102-1 and the second BS 102-2, respectively. The direct communication channels between the UE 104 and the BS 102 can be through interfaces such as an Uu interface, which is also known as E-UTRA air interface. In some embodiments, the UE 104 comprises a plurality of transceivers which enables the UE 104 to support dual connectivity so as to receive data simultaneously from the first BS 102-1 and the second BS 102-2. The first and second BS 102-1 and 102-2 each is connected to a core network (CN) 108 through an external interface 107, e.g., an Iu interface, an NG-U interface, or an S1-U interface. In some other embodiment, the first BS 102-1 (gNB) is a Master Node (MN), which is connected to the CN 108 and the second BS 102-2 (gNB) is a Secondary Node (SN), which is also connected to the CN 108. In some embodiments, the first BS 102-1 (MN) and the second BS 102-2 (SN) are Radio Access Network (RAN) 106. In some embodiments, the CN 108 comprises at least one of the following: Access and Mobility Management Function (AMF), User Plane Function (UPF), and System Management Function (SMF).

In some other embodiments, when the first BS 102-1 and the second BS 102-2 each is a gNB, the direct communication between the first BS 102-1 and the second BS 102-2 is through an Xn-U interface. The first BS 102-1 and the second BS 102-2 are neighboring BSs. A first serving cell 110-1 is covered by the first BS 102-1 and the second serving cell 110-2 is covered by the second BS 102-2. In some embodiments, the first cell 110-1 is a primary cell of the MN, known as PCell, and the second cell 110-2 is a primary cell of the SN, known as PSCell. In some embodiments, the first cell 110-1 and the second cell 110-2 are neighboring cells.

In some embodiments, at least one Protocol Data Unit (PDU) session is established between the CN 108 and at least one of the RAN 106, i.e., BS 102-1 (MN) or BS 102-2 (SN). Each of the at least one PDU session comprises at least one Quality of Service Flow (QF). In some embodiments, each of the at least one PDU session comprises at least two QFs, the at least two QFs of one of the at least one PDU session can be split into at least two separate parts which can be transmitted between the UE 104 and the first BS 102-1 (MN) and between the UE 104 and the BS 102-2 (SN). For example, at least two QFs within one PDU session can be split into a first part (i.e., at least one first QFs) that can be transmitted from the first BS 102-1 to the UE 104 and a second part (i.e., at least one second QFs) that can be transmitted from the second BS 102-2 to the UE 104. In some embodiments, the splitting of the at least two QFs of a PDU session is determined by the first BS 102-1 (MN). For example, when the at least one first QF of a PDU session is transmitted to the UE 104 through the first BS 102-1 and the at least one second QF of the PUD session is transmitted to the UE 104 through the second BS 102-2, (i.e., split PDU session), a first GPRS Tunnel Protocol User (GTP-U) Channel is established between the UPF of the CN 108 and the first BS 102-1 (MN); and a second GTP-U Channel is established between the UPF of the CN 108 and the second BS 102-2 (SN). For another example, when the at least two QFs of the PDU session are transmitted to the UE 104 through only the first BS 102-1 (MN) or the second BS 102-2 (SN) (i.e., non-split PDU session), only one GTP-U Channel is established between the UPF of the CN 108 and one of the RAN (i.e., BS 102-1 or BS 102-2). In some embodiments, at least one GTP-U Channel, hereinafter a user plane (UP) connection, is established between the UPF of the CN 108 and the RAN 106 (e.g., BS 102-1 and/or BS 102-2). In some embodiments, each of the at least one user plane connection comprises a pair of uplink (UL) and downlink (DL) UP transport network layer (TNL) addresses, hereinafter a UL address and a DL address in the present disclosure. In some embodiments, a UL address is used to transmit data from the RAN 106 (e.g., BS 102-1 and/or BS 102-2) to the CN 108; and similarly, a DL address is used to transmit data from the CN 108 to the RAN 106 (e.g., BS 102-1 and/or BS 102-2).

In some embodiments, the UL address is configured by the CN 108 and the DL address is configured by the RAN 106. In some embodiments, no more than one of the transport layer addresses in two UP connections (e.g., UL address or DL address) can be the same. In some embodiments, the first BS 102-1 splits two QFs in a PDU session into 2 parts, i.e., a first QF transmitted to the UE 104 from the first BS 102-1 and a second QF transmitted to the UE 104 from the second BS 102-2. In some embodiments, the first BS 102-1 configures 2 UL addresses for the PDU session, i.e., a first UL address for the first BS 102-1 (MN) and a second UL address for the second BS 102-2 (SN). In some embodiments, the first UL address corresponds to a first DL address on the first BS 102-1; and the second UL address corresponds to a second DL address on the second BS 102-2. In this case, two UP connections are established between the CN 108 and the RAN 106 (e.g., BS 102-1 and BS 102-2), i.e., a first UP connection between the CN 108 and the first BS 102-1, and a second UP connection between the CN 108 and the second BS 102-2.

FIG. 1B illustrates a block diagram of an exemplary wireless communication system 150, in accordance with some embodiments of the present disclosure. The system 150 may include components and elements configured to support known or conventional operating features that need not be described in detail herein. In some embodiments, the system 150 can be used to transmit and receive data symbols in a wireless communication environment such as the wireless communication network 100 of FIG. 1A, as described above.

The system 150 generally includes a first BS 102-1, a second BS 102-2, and a UE 104, collectively referred to as BS 102 and UE 104 below for ease of discussion. The first BS 102-1 and the second BS 102-2 each comprises a BS transceiver module 152, a BS antenna array 154, a BS memory module 156, a BS processor module 158, and a network interface 160. In the illustrated embodiment, each module of the BS 102 are coupled and interconnected with one another as necessary via a data communication bus 180. The UE 104 comprises a UE transceiver module 162, a UE antenna 164, a UE memory module 166, a UE processor module 168, and an I/O interface 169. In the illustrated embodiment, each module of the UE 104 are coupled and interconnected with one another as necessary via a date communication bus 190. The BS 102 communicates with the UE 104 via a communication channel 192, which can be any wireless channel or other medium known in the art suitable for transmission of data as described herein.

As would be understood by persons of ordinary skill in the art, the system 150 may further include any number of modules other than the modules shown in FIG. 1B. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present invention.

A wireless transmission from a transmitting antenna of the UE 104 to a receiving antenna of the BS 102 is known as an uplink (UL) transmission, and a wireless transmission from a transmitting antenna of the BS 102 to a receiving antenna of the UE 104 is known as a downlink (DL) transmission. In accordance with some embodiments, the UE transceiver 162 may be referred to herein as an “uplink” transceiver 162 that includes a RF transmitter and receiver circuitry that are each coupled to the UE antenna 164. A duplex switch (not shown) may alternatively couple the uplink transmitter or receiver to the uplink antenna in time duplex fashion. Similarly, in accordance with some embodiments, the BS transceiver 152 may be referred to herein as a “downlink” transceiver 152 that includes RF transmitter and receiver circuitry that are each coupled to the antenna array 154. A downlink duplex switch may alternatively couple the downlink transmitter or receiver to the downlink antenna array 154 in time duplex fashion. The operations of the two transceivers 152 and 162 are coordinated in time such that the uplink receiver is coupled to the uplink UE antenna 164 for reception of transmissions over the wireless communication channel 192 at the same time that the downlink transmitter is coupled to the downlink antenna array 154. Preferably, there is close synchronization timing with only a minimal guard time between changes in duplex direction. The UE transceiver 162 communicates through the UE antenna 164 with the BS 102 via the wireless communication channel 192. The BS transceiver 152 communications through the BS antenna 154 of a BS (e.g., the first BS 102-1) with the other BS (e.g., the second BS 102-2) via a wireless communication channel 196. The wireless communication channel 196 can be any wireless channel or other medium known in the art suitable for direct communication between BSs.

The UE transceiver 162 and the BS transceiver 152 are configured to communicate via the wireless data communication channel 192, and cooperate with a suitably configured RF antenna arrangement 154/164 that can support a particular wireless communication protocol and modulation scheme. In some exemplary embodiments, the UE transceiver 162 and the BS transceiver 152 are configured to support industry standards such as the Long Term Evolution (LTE) and emerging 5G standards (e.g., NR), and the like. It is understood, however, that the invention is not necessarily limited in application to a particular standard and associated protocols. Rather, the UE transceiver 162 and the BS transceiver 152 may be configured to support alternate, or additional, wireless data communication protocols, including future standards or variations thereof.

The processor modules 158 and 168 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 158 and 168, respectively, or in any practical combination thereof. The memory modules 156 and 166 may be realized as RAM memory, flash memory, ROM memory, EPROM memory, EEPROM memory, registers, a hard disk, a removable disk, a CD-ROM, or any other form of storage medium known in the art. In this regard, the memory modules 156 and 166 may be coupled to the processor modules 158 and 168, respectively, such that the processors modules 158 and 168 can read information from, and write information to, memory modules 156 and 166, respectively. The memory modules 156 and 166 may also be integrated into their respective processor modules 158 and 168. In some embodiments, the memory modules 156 and 166 may each include a cache memory for storing temporary variables or other intermediate information during execution of instructions to be executed by processor modules 158 and 168, respectively. The memory modules 156 and 166 may also each include non-volatile memory for storing instructions to be executed by the processor modules 158 and 168, respectively.

The network interface 160 generally represents the hardware, software, firmware, processing logic, and/or other components of the base station 102 that enable bi-directional communication between BS transceiver 152 and other network components and communication nodes configured to communication with the BS 102. For example, network interface 160 may be configured to support internet or WiMAX traffic. In a typical deployment, without limitation, network interface 160 provides an 802.3 Ethernet interface such that BS transceiver 152 can communicate with a conventional Ethernet based computer network. In this manner, the network interface 160 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 160 could allow the BS 102 to communicate with other BSs or a CN over a wired or wireless connection.

Referring again to FIG. 1A, as mentioned above, the BS 102 repeatedly broadcasts system information associated with the BS 102 to one or more UEs 104 so as to allow the UEs 104 to access the network within the cells (e.g., 110-1 for the first BS 102-1 and 110-2 for the second BS 102-2) where the BS 102 is located, and in general, to operate properly within the cell. Plural information such as, for example, downlink and uplink cell bandwidths, downlink and uplink configuration, cell information, configuration for random access, etc., can be included in the system information, which will be discussed in further detail below. Typically, the BS 102 broadcasts a first signal carrying some major system information, for example, configuration of the cell 110 through a PBCH (Physical Broadcast Channel). For purposes of clarity of illustration, such a broadcasted first signal is herein referred to as “first broadcast signal.” It is noted that the BS 102 may subsequently broadcast one or more signals carrying some other system information through respective channels (e.g., a Physical Downlink Shared Channel (PDSCH)).

Referring again to FIG. 1B, in some embodiments, the major system information carried by the first broadcast signal may be transmitted by the BS 102 in a symbol format via the communication channel 192 (e.g., a PBCH). In accordance with some embodiments, an original form of the major system information may be presented as one or more sequences of digital bits and the one or more sequences of digital bits may be processed through plural steps (e.g., coding, scrambling, modulation, mapping steps, etc.), all of which can be processed by the BS processor module 158, to become the first broadcast signal. Similarly, when the UE 104 receives the first broadcast signal (in the symbol format) using the UE transceiver 162, in accordance with some embodiments, the UE processor module 168 may perform plural steps (de-mapping, demodulation, decoding steps, etc.) to estimate the major system information such as, for example, bit locations, bit numbers, etc., of the bits of the major system information. The UE processor module 168 is also coupled to the I/O interface 169, which provides the UE 104 with the ability to connect to other devices such as computers. The I/O interface 169 is the communication path between these accessories and the UE processor module 168.

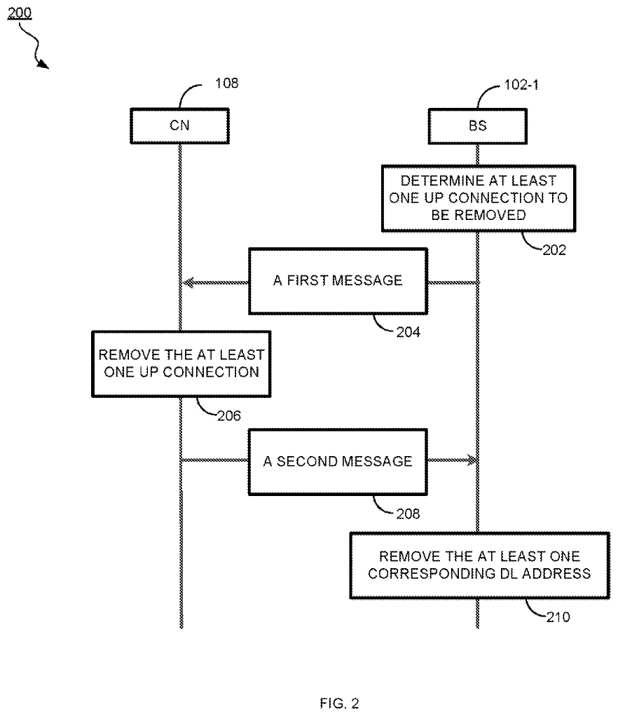

FIG. 2 illustrates a method 200 for removing a user plan connection, in accordance with some embodiments of the present disclosure. It is understood that additional operations may be provided before, during, and after the method 200 of FIG. 2, and that some operations may be omitted or reordered. The communication system in the illustrated embodiment comprises a CN 108 and a RAN 106 (e.g., a first BS 102-1, and a second BS 102-2). In the illustrated embodiments, a UE 104 (not shown) is in one of at least one serving cell covered by the first BS 102-1 and also in one of at least one serving cell covered by the second BS 102-2, i.e., the UE 104 is in connection with the first BS 102-1 and the second BS 102-2. In some embodiments, the first BS 102-1 is a primary wireless communication node and the second BS 102-2 is a secondary wireless communication node. In the illustrated embodiments, at least two QFs of a PDU session are split into at least one first QF and at least one second QF, which are transmitted between the first BS 102-1 and the UE 104, and between the second BS 102-2 and the UE 104, respectively. In the illustrated embodiments, two UP connections are established between the CN 108 and the first BS 102-1, and between the CN 108 and the second BS 102-2. FIG. 2 with 2 UP connections is for illustration purposes and is not intend to be limiting. It should be noted that that any numbers of BS 102 in the RAN 106 can be used; any numbers of UP connections can be established between the CN 108 and the RAN 106; any numbers of PDU sessions can exists; and any numbers of UP connections can be removed, which are all within the scope of this invention.

The method 200 starts with operation 202 in which a first UP connection to be removed is determined by the RAN 106, according to some embodiments. In some embodiments, prior to operation 202, two UP connections are established between the RAN 106 and the CN 108, i.e., one between the first BS 102-1 and the CN 108, and one between the second BS 102-2 and the CN 108. In some embodiments, the first BS 102-1 of the RAN 106 determines the first UP connection which is configured to transmit the at least one first QF in the PDU session and also determines the second UP connection which is configured to transmit the at least one second QFs in the PDU session. In some embodiments, the first UP connection is determined according to a reorganized QF in the at least one PDU session. For example, when the first BS 102-1 determines to merge the at least one first QF and the at least one second QF which are further transmitted through the second BS 102-1, the UP connection between the CU 108 and the first BS 102-1 is the first UP connection to be removed. Similarly, when the first BS 102-1 determines to merge the at least one first QF and the at least one second QF which are further transmitted through the first BS 102-1, the UP connection between the CU 108 and the second BS 102-2 is the first UP connection to be removed.

In some embodiments, when the first UP connection is removed, the first UP connection becomes unused and becomes available for carrying QF of other PDU sessions if needed. In some embodiments, the RAN 106 (i.e., the first BS 102-1) can also determine to switch from a split PDU session to a non-split PDU session by removing the at least one first UP connection and keeping only one UP connection which can be configured between the first BS 102-1 and the CN 108 or between the second BS 102-2 and the CN 108.

The method 200 continues with operation 204 in which a first message is transmitted from the RAN 106 to the CN 108 according to some embodiments. In some embodiments, the first message is an indication message, comprising information of a DL address of the first UP connection. In some embodiments, the first message also comprises information of a corresponding UL address of the DL address of the first UP connection. In some embodiments, the first message is a PDU Session Resource Modify Indication message. In some embodiments, the information of the DL address and/or the corresponding UL address of the first UP connection is included in at least one information entity (IE) of the first message. In some embodiments, the at least one IE is included in a PDU Session Resource Modify Indication Transfer. In some embodiments, the at least one IE comprises at least one of the following: a DL UP Transport Network Layer (TNL) Removal List, UL UP TNL Information, and DL UP TNL Information.

In some embodiments, the first message further comprises update information of the two QFs of the PDU session on a second UP connection. In some embodiments, the first QF on the first UP connection to be removed is configured or offloaded to the second UP connection which are not removed to ensure that the first QF continues data transmission on the second UP connection.

The method 200 continues with operation 206 in which the first UP connection is removed by the CN 108 according to some embodiments. In some embodiments, after the first UP connection is removed by the CN 108, the corresponding UL address of the DL address of the first UP connection is further removed by the CN 108. In some embodiments, the corresponding UL address and the DL address can be further stored in the CN 108. In some embodiments, when the corresponding UL address of the DL address is not received in the first message, the CN 108 can determine the corresponding UL address in stored information of an UL/DL address pair and further remove the corresponding UL address. In some embodiments, when the corresponding UL address is removed, the at least one corresponding UL address becomes unused and available for carrying a QF of other PDU sessions.

The method 200 continues with operation 208 in which a second message is received by the RAN 106 from the CN 108 according to some embodiments. In some embodiments, the second message is a PDU Session Resource Modify Confirm message. In some embodiments, the second message is transmitted by the CN 108 to the RAN 106 before the corresponding UL address is removed.

The method 200 continues with operation 210 in which the DL address is removed by the RAN 106 according to some embodiments. In some embodiments, the first UP connection is removed so that the DL address and the corresponding UL address can be removed and then become unused.

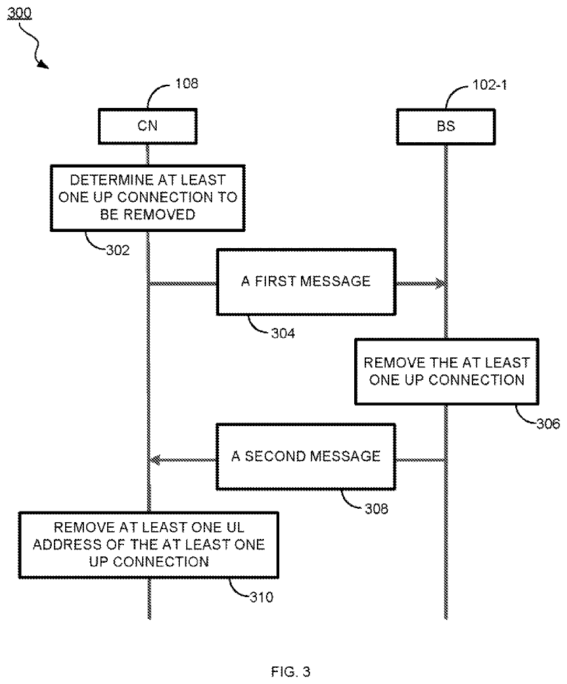

FIG. 3 illustrates a method 300 for removing a user plane connection, in accordance with some embodiments of the present disclosure. It is understood that additional operations may be provided before, during, and after the method 300 of FIG. 3, and that some operations may be omitted or reordered. The communication system in the illustrated embodiment comprises a CN 108 and a RAN 106 (e.g., a first BS 102-1, and a second BS 102-2). In the illustrated embodiments, a UE 104 (not shown) is in one of at least one serving cell covered by the first BS 102-1 and also in one of at least one serving cell covered by the second BS 102-2, i.e., the UE 104 is in connection with the first BS 102-1 and the second BS 102-2. In some embodiments, the first BS 102-1 is a primary wireless communication node and the second BS 102-2 is a secondary wireless communication node. In the illustrated embodiments, two QFs of a PDU session are split into a first QF and a second QF, which are transmitted between the first BS 102-1 and the UE 104, and between the second BS 102-2 and the UE 104, respectively. In the illustrated embodiments, two UP connections are established between the CN 108 and the first BS 102-1, and between the CN 108 and the second BS 102-2. FIG. 3 with 2 UP connections is for illustration purposes and is not intend to be limiting. It should be noted that that any numbers of BS 102 in the RAN 106 can be used; any numbers of UP connections can be established between the CN 108 and the BS 102; any numbers of PDU sessions can exists; and any numbers of UP connections can be removed, which are all within the scope of this invention.

The method 300 starts with operation 302 in which a first UP connection in the PDU session to be removed is determined by the CN 108, according to some embodiments. In the illustrated embodiment, prior to operation 302, two UP connections are established between the RAN 106 and the CN 108, i.e., one between the first BS 102-1 and the CN 108, and one between the second BS 102-2 and the CN 108. In the illustrated embodiment, the CN 108 determines the first UP connection which is configured to transmit one part of the QF in the PDU session. In some embodiments, the first UP connection to be removed is determined according to a reorganized QF in the PDU session. For example, when the CU 108 determines to merge the first QF and the second QF which are further transmitted through the second BS 102-2, the UP connection between the CU 108 and the first BS 102-1 is the first UP connection to be removed. Similarly, when the CU 108 determines to merge the first QF and the second QF which are further transmitted through the first BS 102-1, the UP connection between the CU 108 and the second BS 102-2 is the first UP connection to be removed. In some embodiments, when a first UP connection is removed, the first UP connection becomes unused and available for QF of other PDU sessions. In some embodiments, the CN 108 can also determine to switch from a split PDU session to a non-split PDU session by removing the at least one first UP connection.

The method 300 continues with operation 304 in which a first message is received by the RAN 106 from the CN 108 according to some embodiments. In some embodiments, the first message is a request message, comprising information of a UL address of the first UP connection. In some embodiments, the first message also comprises information of a corresponding DL address of the UL address of the first UP connection. In some embodiments, the first message is a PDU Session Resource Modify Request message. In some embodiments, information of the UL address and/or the corresponding DL address of the first UP connection is included in at least one information entity (IE) of the first message. In some embodiments, the at least one IE is included in a PDU Session Resource Modify Request Transfer. In some embodiments, the at least one IE comprises at least one of the following: a DL UP Transport Network Layer (TNL) Removal List, UL UP TNL Information, and DL UP TNL Information.

The method 300 continues with operation 306 in which the first UP connection is removed by the RAN 106 according to some embodiments. In some embodiments, after the first UP connection is removed, the corresponding DL address of the first UP connection is removed by the first BS 102-1. In some embodiments, the information of the UL address and the corresponding DL address can be further stored in the first BS 102-1. In some embodiments, when the corresponding DL address of the UL address is not received in the first message, the first BS 102-1 determines the corresponding DL address in stored information and further remove the corresponding DL address.

The method 300 continues with operation 308 in which a second message is transmitted from the RAN 106 to the CN 108 according to some embodiments. In some embodiments, the second message is a PDU Session Resource Modify Response message. In some embodiments, the second message further comprises update information of the QF on a second UP connection. In some embodiments, a first part of the QF on the first UP connection to be removed is reconfigured to the second UP connection which are determined not to be removed to ensure that the QF continues data transmission on the second UP connection.

The method 300 continues with operation 310 in which the UL address of the first UP connection is removed by the CN 108 according to some embodiments.?] In some embodiments, the UL address of the first UP becomes unused and available for QF of other PDU sessions.

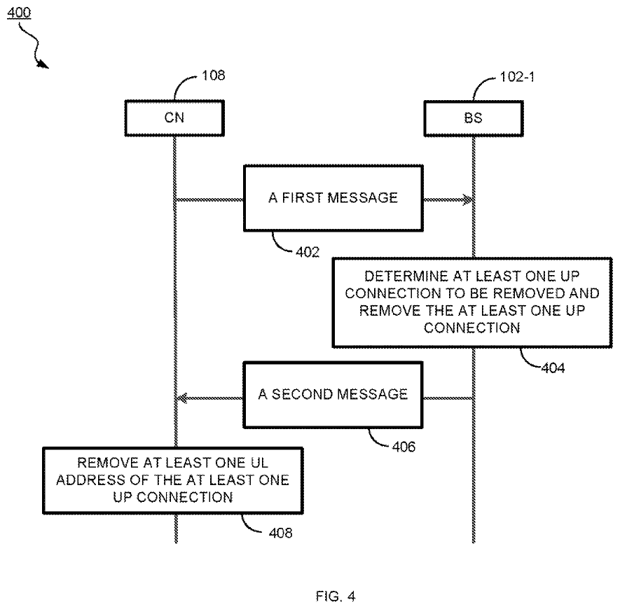

FIG. 4 illustrates a method 400 for removing a UP connection, in accordance with some embodiments of the present disclosure. It is understood that additional operations may be provided before, during, and after the method 400 of FIG. 4, and that some operations may be omitted or reordered. The communication system in the illustrated embodiment comprises a CN 108 and a RAN 106 (e.g., a first BS 102-1, and a second BS 102-2). In the illustrated embodiments, a UE 104 (not shown) is in one of at least one serving cell covered by the first BS 102-1 and also in one of at least one serving cell covered by the second BS 102-2, i.e., the UE 104 is in connection with the first BS 102-1 and the second BS 102-2. In some embodiments, the first BS 102-1 is a primary wireless communication node and the second BS 102-2 is a secondary wireless communication node. In the illustrated embodiments, two QFs of a PDU session are split into a first QF and a second QF, which are transmitted between the first BS 102-1 and the UE 104, and between the second BS 102-2 and the UE 104, respectively. In the illustrated embodiments, two UP connections are established between the CN 108 and the first BS 102-1, and between the CN 108 and the second BS 102-2. FIG. 4 with 2 UP connections is for illustration purposes and is not intend to be limiting. It should be noted that that any numbers of BS 102 in the RAN 106 can be used; any numbers of UP connections can be established between the CN 108 and the BS 102; any numbers of PDU sessions can exists; and any numbers of UP connections can be removed, which are all within the scope of this invention.

The method 400 starts with operation 402 in which a first message is received by the RAN 106 from the CN 108 according to some embodiments. In some embodiments, prior to operation 302, two UP connections are established between the RAN 106 and the CN 108, i.e., one between the first BS 102-1 and the CN 108, and one between the second BS 102-2 and the CN 108. In some embodiments, the CN 108 determines a transmission of the first QF in the PDU session is accomplished. In some embodiments, the first message is a request message. In some embodiments, the first message is a PDU Session Resource Modify Request message. In some embodiments, the first message comprises information of the first QF in the at least one PDU session. In some embodiments, the first QF is carried on a first UP connection.

The method 400 continues with operation 404 in which the first UP connection to be removed is determined by the RAN 106, according to some embodiments. In some embodiments, the first BS 102-1 determines the first UP connection according to the first QF received in the first message. In some embodiments, the first UP connection is removed by the first BS 102-1. In some embodiments, after the first UP connection is removed, a DL address of the first UP connection is removed by the first BS 102-1. In some embodiments, when the DL address of the first UP connection is removed, the DL address becomes unused and available for QF of other PDU sessions.

The method 400 continues with operation 406 in which a second message is transmitted from the RAN 106 to the CN 108 according to some embodiments. In some embodiments, the second message is a PDU Session Resource Modify Response message. In some embodiments, the second message further comprises update information of the second QF. In some embodiments, the first QF on the first UP connection to be removed is reconfigured to a second UP connection which is not to be removed to ensure that the first QF continues data transmission on the second UP connection.

In some embodiments, the second message further comprises a UL address of the first UP connection. In some embodiments, the second message also comprises information of the DL address the first UP connection. In some embodiments, the information of the DL address and/or the corresponding UL address of the first UP connection is included in at least one information entity (IE) of the first message. In some embodiments, the at least one IE is included in a PDU Session Resource Modify Response Transfer. In some embodiments, the at least one IE is at least one of the following: a UL NG-U UP TNL Removal List, UL NG-U UP TNL Information, and DL NG-U UP TNL Information.

The method 400 continues with operation 408 in which the first UP connection is removed by the CN 108 according to some embodiments. In some embodiments, after the first UP connection is removed, the corresponding UL address of the first UP connection is removed by the CN 108. In some embodiments, the information of the DL address and the corresponding UL address can be further stored in the CN 108. In some embodiments, when the corresponding UL address of the DL address is not received in the second message, the CN 108 determines the corresponding UL address in stored information and further remove the corresponding UL address.

While various embodiments of the invention have been described above, it should be understood that they have been presented by way of example only, and not by way of limitation. Likewise, the various diagrams may depict an example architectural or configuration, which are provided to enable persons of ordinary skill in the art to understand exemplary features and functions of the invention. Such persons would understand, however, that the invention is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two, which can be designed using source coding or some other technique), various forms of program or design code incorporating instructions (which can be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware, firmware or software, or a combination of these technique, depends upon the particular application and design constraints imposed on the overall system. Skilled artisans can implement the described functionality in various ways for each particular application, but such implementation decisions should not be interpreted as causing a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A method for removing at least one first user plane (UP) connection by a first wireless communication node, comprising:
determining the at least one first UP connection to be removed from a plurality of UP connections; and
transmitting a first message to a second wireless communication node,
wherein the first message comprises at least one Downlink-Transport Network Layer (DL-TNL) address of the at least one first UP connection to be removed.

2. The method of claim 1, wherein the first message further comprises at least one information entity (IE), wherein the at least one IE comprises at least one Uplink/Downlink (UL/DL) TNL address pair corresponding to the at least one first UP connection, wherein the at least one UL/DL TNL address pair each comprises a UL-TNL address and a DL-TNL address.

3. The method of claim 1, wherein the first message further comprises Quality of Service Flow (QF) information of at least one second UP connection in the plurality of UP connections, wherein the at least one second UP connection is not removed.

4. The method of claim 1, wherein the first message is a Protocol Data Unit (PDU) Session Resource Modify Indication message.

5. The method of claim 1, further comprising:
after the transmitting, receiving a second message from the second wireless communication node; and
removing at least one DL-TNL address of the at least one first UP connection,
wherein the second message is a PDU Session Resource Modify Confirm message.

6. The method of claim 1, further comprising:
prior to the determining, receiving a second message from the second wireless communication node, wherein the second message is a PDU Session Resource Request message, and wherein the first message is PDU Session Resource Response message.

7. The method of claim 6, wherein the second message comprises information of Quality of Service Flow (QF) on at least one second UP connection.

8. A method for removing at least one first user plane (UP) connection by a first wireless communication node, comprising:
receiving a first message from a second wireless communication node,
wherein the first message comprises at least one downlink transport network layer (DL-TNL) address of the at least one first UP connection to be removed from a plurality of UP connections, and wherein the at least one first UP connection to be removed is determined by the second wireless communication node.

9. The method of claim 8, wherein the first message further comprises at least one information entity (IE), wherein the at least one IE comprises at least one Uplink/Downlink (UL/DL) TNL address pair corresponding to the at least one first UP connection, wherein the at least one UL/DL TNL address pair each comprises a UL-TNL address and a DL-TNL address.

10. The method of claim 8, wherein the first message further comprises Quality of Service Flow (QF) information of at least one second UP connection in the plurality of UP connections, wherein the at least one second UP connection is not removed.

11. The method of claim 8, wherein the first message is a Protocol Data Unit (PDU) Session Resource Modify Indication message.

12. The method of claim 8, further comprising:
after the receiving, removing the at least one first UP connection;
removing the at leas one UL-TNL address of the at least one first UP connection;
transmitting a second message to the first wireless communication node; and
removing at least one DL-TNL address of the at least one first UP connection by the second wireless communication node,
wherein the second message is a PDU Session Resource Modify Confirm message.

13. The method of claim 8, further comprising:
prior to the receiving, transmitting a second message to the first wireless communication node, wherein the second message is a PDU Session Resource Request message, and wherein the first message is PDU Session Resource Response message.

14. The method of claim 13, wherein the second message comprises information of Quality of Service Flow (QF) on at least one second UP connection.

15. A method for removing at least one first user plane (UP) connection by a first wireless communication node, comprising:
receiving a first message from a second wireless communication node, wherein the first message comprises the at least one first UP connection to be removed;
removing the at least one first UP connection from a plurality of UP connections; and
transmitting a second message to the second wireless communication node,
wherein the at least one first UP connection is determined by the second wireless communication node, and wherein the first message further comprises at least one Uplink-Transport Network Layer (UL-TNL) address of the at least one first UP connection.

16. The method of claim 15, wherein the first message further comprises at least one information entity (IE), wherein the at least one IE comprises at least one Uplink/Downlink (UL/DL) TNL address pair corresponding to the at least one first UP connection, wherein the at least one UL/DL TNL address pair each comprises a UL-TNL address and a DL-TNL address.

17. The method of claim 16, further comprising:
after the removing, removing the at least one DL-TNL address of the at least one first UP connection.

18. The method of claim 15, wherein the second message further comprises Quality of Service Flow (QF) information of at least one second UP connection in the plurality of UP connections, wherein the at least one second UP connection is not removed.

19. The method of claim 15, wherein the first message is a PDU Session Resource Modify Request message and the second message is a PDU Session Resource Modify Response message.

20. A computing device comprising at least one processor configured to carry out the method of claim 1.
